(19) United States
(12) Patent Application Publication
(10) Pub. No.: US 2009/0104497 A1
(43) Pub. Date: Apr. 23, 2009

(54) FUEL ELECTRODE CATALYST, METHOD FOR PRODUCING FUEL ELECTRODE CATALYST, FUEL CELL, AND METHOD FOR PRODUCING FUEL CELL

(75) Inventors: Yuji SASAKI, Kanagawa-ken (JP); Takahiro Terada, Kanagawa-ken (JP); Yasutada Nakagawa, Kanagawa-ken (JP); Hirofumi Kan, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/253,577

(22) Filed: Oct. 17, 2008

(30) Foreign Application Priority Data
Oct. 18, 2007 (JP) 2007-271788
Oct. 15, 2008 (JP) 2008-266678

(51) Int. Cl. H01M 4/92; H01M 8/10; B01J 23/652; B01J 27/20; H01M 4/88

(52) U.S. Cl. 429/30; 29/623.1; 502/313; 502/174; 502/101

(57) ABSTRACT

A fuel electrode catalyst includes: a solid solution of platinum (Pt) and molybdenum (Mo), a crystal structure of the solid solution being a face-centered cubic structure, and a component ratio of the molybdenum (Mo) in the solid solution being from 10 atom % (at %) to 20 atom % (at %), and a method for producing a fuel electrode catalyst, includes: generating platinum hydrate and molybdenum oxide from chloroplatinic acid (H₂PtCl₆) and sodium molybdate dihydrate (Na₂MoO₄.2H₂O); reducing the platinum hydrate and the molybdenum oxide; and therewith solid-solving molybdenum (Mo) into platinum (Pt).

### CROSS-REFERENCE TO RELATED APPLICATIONS

This application is based upon and claims the benefit of priority from the prior Japanese Patent Application Nos. 2007-271788, filed on Oct. 18, 2007 and 2008-266678, filed on Oct. 15, 2008; the entire contents of which are incorporated herein by reference.

### BACKGROUND OF THE INVENTION

1. Field of the Invention

This invention relates to a fuel electrode catalyst used in a fuel electrode of a fuel cell, a method for producing the fuel electrode catalyst, the fuel cell, and a method for producing the fuel cell.

2. Background Art

With the advancement of electronics in recent years, electronic devices have become more downsized, more powerful, and more portable. In particular, downsizing and higher energy density for the cells used therein have become more required. Hence, downsized and lightweight fuel cells having high capacity has been emphasized. In particular, Direct Methanol Fuel Cell (DMFC) in which methanol serves as the fuel is more suitable for downsizing than a fuel cell using hydrogen gas because there is no difficulty in handling hydrogen gas and a device and such for producing hydrogen by modifying a liquid fuel is not required.

In the direct methanol fuel cell, a fuel electrode (anode electrode) and a solid electrolyte membrane and an air electrode (cathode electrode) are sequentially provided contiguously to one another to form a membrane electrode assembly. And, a fuel (methanol) is supplied to the fuel electrode side, and the fuel (methanol) is oxidized by a catalyst in the vicinity of the polyelectrolyte membrane to take out proton (H⁺) and electron (e⁻).

Here, platinum (Pt) is used as the catalyst for the oxidation in the fuel electrode, but there is a problem of catalyst poisoning that surface of the catalyst is covered with carbon monoxide generated in oxidizing the fuel (methanol) to degrade the function of the fuel electrode.

Therefore, there has been proposed a catalyst that can suppress the catalyst poisoning due to carbon monoxide (JP-A 10-228912 (Kokai)).

However, in the catalyst disclosed in JP-A 10-228912 (Kokai), an element generating bronze or an oxide thereof is approximated to an alloy of platinum (Pt). Therefore, when the alloy of platinum (Pt) is formed, the face-centered cubic structure, which is a basic structure of platinum single crystal, collapses and the catalyst function of the platinum (Pt) is in danger of being degraded. Moreover, because the catalyst is a ternary catalyst to which the element generating bronze or the oxide thereof is added, the occupation ratio of platinum (Pt) or the occupation ratio of an element or the like added for suppressing the catalyst poisoning is reduced, and therefore adversely, the catalyst function of the platinum (Pt) is in danger of being lowered or the function of suppressing the catalyst poisoning of the added element is in danger of being lowered.

### SUMMARY OF THE INVENTION

According to an aspect of the invention, there is provided a fuel electrode catalyst including: a solid solution of platinum (Pt) and molybdenum (Mo), a crystal structure of the solid solution being a face-centered cubic structure, and a component ratio of the molybdenum (Mo) in the solid solution being from 10 atom % (at %) to 20 atom % (at %).

According to another aspect of the invention, there is provided a fuel electrode catalyst including: a solid solution of platinum (Pt) and tungsten (W), a crystal structure of the solid solution being a face-centered cubic structure, and a component ratio of the tungsten (W) in the solid solution being from 10 atom % (at %) to 50 atom % (at %).

According to another aspect of the invention, there is provided a method for producing a fuel electrode catalyst, including: generating platinum hydrate and molybdenum oxide from chloroplatinic acid (H₂PtCl₆) and sodium molybdate dihydrate (Na₂MoO₄.2H₂O); reducing the platinum hydrate and the molybdenum oxide; and therewith solid-solving molybdenum (Mo) into platinum (Pt).

According to another aspect of the invention, there is provided a method for producing a fuel electrode catalyst, including: generating platinum hydrate and tungsten oxide from chloroplatinic acid (H₂PtCl₆) and sodium tungstate dihydrate (Na₂WO₄.2H₂O); reducing the platinum hydrate and the tungsten oxide; and therewith solid-solving tungsten (W) into platinum (Pt).

According to another aspect of the invention, there is provided a method for producing a fuel cell including a fuel electrode to which fuel is supplied, an air electrode to which oxidant is supplied and a solid polyelectrolyte membrane provided to be sandwiched between the fuel electrode and the air electrode, including: producing a fuel electrode catalyst contained in the fuel electrode by a method for producing a fuel electrode catalyst, including: generating platinum hydrate and molybdenum oxide from chloroplatinic acid (H₂PtCl₆) and sodium molybdate dihydrate (Na₂MoO₄.2H₂O); reducing the platinum hydrate and the molybdenum oxide; and therewith solid-solving molybdenum (Mo) into platinum (Pt).

According to another aspect of the invention, there is provided a method for producing a fuel cell including a fuel electrode to which fuel is supplied, an air electrode to which oxidant is supplied and a solid polyelectrolyte membrane provided to be sandwiched between the fuel electrode and the air electrode, including: producing a fuel electrode catalyst contained in the fuel electrode by a method for producing a fuel electrode catalyst, including: generating platinum hydrate and tungsten oxide from chloroplatinic acid (H₂PtCl₆) and sodium tungstate dihydrate (Na₂WO₄.2H₂O); reducing the platinum hydrate and the tungsten oxide; and therewith solid-solving tungsten (W) into platinum (Pt).

### BRIEF DESCRIPTION OF THE DRAWINGS

FIG. 1 is a flow chart for explaining the method for producing a fuel electrode catalyst according to a first embodiment of this invention;

FIG. 2 is a flow chart for explaining the method for producing a fuel electrode catalyst according to a second embodiment of this invention;

FIG. 3 is a schematic view for illustrating a fuel cell according to an embodiment of this invention; and

FIG. 4 is a flow chart for explaining a method for producing a fuel cell according to an embodiment of this invention.

### DETAILED DESCRIPTION OF THE INVENTION

Hereinafter, embodiments of this invention will be exemplified with reference to drawings.

The fuel electrode catalyst according to an embodiment of this invention has a “mixture” of platinum (Pt) and group 6 element of periodic table. Here, the “mixture” is a form that can maintain a state in which platinum (Pt) and group 6 element of periodic table are approximated and that includes a state in which platinum (Pt) and group 6 element of periodic table are alloyed or a cluster-shaped atomic aggregation of platinum (Pt) and Group 6 element of periodic table.

The crystal of platinum (Pt) used as the catalyst expresses a face-centered cubic structure. Here, it is thought that increase and decrease of electron density relates deeply to the activity, namely, the function as the catalyst, and it is supposed that face-centered cubic structure is more preferable than body-centered cubic structure. Therefore, it is preferable that in solid-solving another element into platinum (Pt), the face-centered cubic structure of platinum (Pt) crystal is maintained.

In this case, for making solid solution so that the face-centered cubic structure of platinum (Pt) is maintained, it is sufficient to select an element having an atomic radius near to that of platinum (Pt).

As a result of investigation, the present inventors have obtained knowledge that when group 6 element having an atomic radius near to that of platinum (Pt), the face-centered cubic structure of the platinum (Pt) crystal is easy to be maintained and therefore lowering of the function as the catalyst can be suppressed. And, the present inventors also have obtained knowledge that when the platinum (Pt) and the group 6 element are “approximated”, the catalyst poisoning due to carbon monoxide can be drastically suppressed. Furthermore, the present inventors also have obtained knowledge that it is preferable to select chromium (Cr), molybdenum (Mo), or tungsten (W), among the group 6 elements.

Hereinafter, suppression of the catalyst poisoning will be explained.

For suppressing the catalyst poisoning due to carbon monoxide, it is sufficient to suppress adsorption of carbon monoxide to platinum (Pt) atom or to make the adsorbed carbon monoxide easy to be dissociated from catalyst surface.

Here, ease of dissociation of carbon monoxide from the catalyst surface can be evaluated by value of activation energy required for the dissociation.

In Table 1, values of activation energy required for the dissociation of carbon monoxide adsorbed to platinum (Pt) atom from catalyst surface are compared.

To Comparative examples 1, 2 in Table 1, investigation has been added in the process that the present investors have achieved this invention, and Examples 1, 2 illustrate fuel electrode catalysts according to this embodiment.

The catalyst of Comparative example 1 in Table 1 is composed of only platinum (Pt). The crystal structure of this case is a face-centered cubic structure and its lattice constant is a=b=c=3.925 angstrom. And, the plane (1 1 1) having large surface atomic density is set to be evaluated.

The catalyst of Comparative example 2 is a platinum-ruthenium solid solution in which ruthenium (Ru), which is one of platinoid elements, is solid-solved into platinum (Pt), and the component ratio of the platinum-ruthenium solid solution is 50 atom % (at %):50 atom % (at %). The crystal structure of this case is a face-centered cubic structure, and its lattice constants are a=b=3.887 angstrom, c=3.913 angstrom. And, the plane (1 1 1) having large surface atomic density is set to be evaluated.

The catalyst of Example 1 is an alloy (mixture) in which molybdenum (Mo), which is one of group 6 elements, is solid-solved to its solid solubility limit with maintaining the face-centered cubic structure that is a basic structure of platinum (Pt) crystal, and the component ratio of the platinum-molybdenum solid solution is 80 atom % (at %):20 atom % (at %). The crystal structure of this case is a face-centered cubic structure, and its lattice constants are a=b=c=3.97 angstrom. And, the plane (1 1 1) having large surface atomic density is set to be evaluated.

The catalyst of Example 2 is an alloy (mixture) in which tungsten (W), which is one of group 6 elements, is solid-solved to its solid solubility limit with maintaining the face-centered cubic structure that is a basic structure of platinum (Pt) crystal, and the component ratio of the platinum-tungsten solid solution is 50 atom % (at %):50 atom % (at %). The crystal structure of this case is a face-centered cubic structure, and its lattice constants are a=b=3.96 angstrom, c=4.09 angstrom. And, the plane (1 1 1) having large surface atomic density is set to be evaluated.

TABLE 1

| | Activation Energy Required for |
|---|---|
| | Dissociating Carbon Monoxide |
| | from Catalyst Surface [eV] |
| Comparative | 1.44 |
| Example 1 | |
| Comparative | 1.08 |
| Example 2 | |
| Example 1 | 0.64 |
| Example 2 | 0.69 |

As seen from Table 1, compared to the catalyst composed of only platinum (Pt) (Comparative example 1) and the catalyst composed of the platinum-ruthenium solid solution (Comparative example 2), activation energy required for dissociating carbon monoxide from the catalyst surface is drastically low in the catalyst composed of the platinum-molybdenum solid solution (Example 1) or in the catalyst composed of the platinum-tungsten solid solution (Example 2). This means that the catalysts of Examples 1, 2 are easier to dissociate the adsorbed carbon monoxide to the catalyst surface and that the surfaces of the catalysts are more difficult to be covered with carbon monoxide. Therefore, the catalyst poisoning due to carbon monoxide can be drastically reduced. Moreover, because the catalysts of Examples 1, 2 maintain the face-centered cubic structure that is a basic structure of platinum (Pt) crystal, lowering of the catalyst function of platinum (Pt) can also be suppressed.

In Table 2, total energies when carbon monoxide is adsorbed to atom in the catalysts are compared.

The left column of Table 2 shows total energies when carbon monoxide is adsorbed to platinum atom in the catalysts, and the right column shows total energies when carbon monoxide is adsorbed to atom except for platinum atom (ruthenium (Ru), molybdenum (Mo), tungsten (W)) in the catalysts.

Moreover, Comparative example 2 represents the above-described catalyst composed of the platinum-ruthenium solid solution, and Example 1 represents the above-described catalyst composed of the platinum-molybdenum solid solution, and Example 2 represents the above-described catalyst composed of the platinum-tungsten solid solution.

Total energy means that as the value thereof is lower, the adsorbing state is stabler.

TABLE 2

| | | Total Energy when Carbon |
|---|---|---|
| | Total Energy when Carbon | Monoxide is Adsorbed to |
| | Monoxide is Adsorbed to | Atom Except for |
| | Platinum Atom [eV] | Platinum Atom [eV] |
| Comparative | −1.08 | −1.85 |
| Example 2 | | |
| Example 1 | −0.64 | −1.74 |
| Example 2 | −0.69 | −1.94 |

As seen from Table 2, compared to the case in which carbon monoxide is adsorbed to platinum atom, the total energy is low in the case in which the carbon monoxide is adsorbed to the solid-solved atom except for platinum atom. That is, carbon monoxide is stabler in the state of being adsorbed to the atom solid-solved into platinum (Pt), and therefore, preferentially adsorbed to the solid-solved atom, and therefore, by the degree thereof, carbon monoxide becomes difficult to be adsorbed to platinum (Pt).

In this case, compared to Comparative example 2, differences of the total energies of Examples 1, 2 are large, and therefore, carbon monoxide is further preferentially adsorbed to the molybdenum (Mo) and the tungsten (W) that are solid-solved into platinum (Pt), and therefore, carbon monoxide becomes more difficult to be adsorbed to platinum (Pt).

As described above, because adsorption of carbon monoxide to platinum (Pt) is further inhibited, it can be drastically suppressed that platinum (Pt) is covered with carbon monoxide. Therefore, the catalyst poisoning due to carbon monoxide can be drastically reduced.

The cases in which atom of the group 6 elements is solid-solved into platinum (Pt) to its solid solubility limit are described above. However, according to knowledge obtained by the present inventors, for example, when a component ratio of the molybdenum (Mo) in the solid solution is from 10 atom % (at %) to 20 atom % (at %) in the case of the platinum-molybdenum solid solution or a component ratio of the tungsten (W) in the solid solution is from 10 atom % (at %) to 50 atom % (at %) in the case of the platinum-tungsten solid solution, the catalyst poisoning due to carbon monoxide can be drastically reduced. Furthermore, instead of singly mixing molybdenum or tungsten into platinum, molybdenum and tungsten may be mixed together into platinum.

Moreover, when the solid solution is made, distance between atoms of platinum (Pt) and group 6 element can be minimum, and therefore, the above-described carbon monoxide is preferentially adsorbed to the group 6 element, and thereby, the effect of inhibiting adsorption of the carbon monoxide to platinum (Pt) can be exerted to the maximum.

However, even when the atoms of platinum (Pt) and group 6 element are physically contacted without making the solid solution, the catalyst poisoning due to carbon monoxide can be reduced. In this case, it is preferable that the atoms of platinum (Pt) and group 6 element are approximated as much as possible.

As a result of further investigation, the present inventors have obtained the knowledge that when the particles composed of atom of group 6 element to be contacted with platinum (Pt) is set to be aggregation composed of more than several and less than several tens of atoms, the catalyst poisoning due to carbon monoxide can be drastically reduced even when the particles are physically contacted.

That is, by setting the particles composed of atom of group 6 element to be very fine, chance that atom of platinum (Pt) and atom of group 6 element become contiguous, and therefore, carbon monoxide can be preferentially adsorbed to sufficiently exert the effect of inhibiting adsorption of carbon monoxide to platinum (Pt).

As described above, according to this embodiment, carbon monoxide generated in the oxidation is preferentially adsorbed to atom group 6 element (such as chromium (Cr), molybdenum (Mo), or tungsten (W)) that is “approximated” to platinum (Pt) to inhibit adsorption to platinum (Pt), and the dissociation becomes easy even when carbon monoxide is adsorbed to platinum (Pt). Therefore, poison resistance of fuel electrode catalyst to carbon monoxide can be improved to maintain the function of the fuel electrode of the fuel cell for a long time.

Moreover, as a technique disclosed in the JP-A 10-228912 (Kokai), in a catalyst in which platinum (Pt) and two or more kinds of atom are solid-solved (such as ternary catalyst), the ratio that the atom of element added for suppressing the catalyst poisoning and the platinum (Pt) atom becomes adversely lowered, and therefore, the above-described poison resistance to carbon monoxide is in danger of being adversely lowered. By contrast, according to this embodiment, only one kind of atom of group 6 element for suppressing the catalyst poisoning is “approximated” to platinum (Pt) exerting the catalyst function, and therefore, the ratio that the atoms become contiguous can be increased to improve the poison resistance to carbon monoxide.

Moreover, in this embodiment, compared to the ternary catalyst disclosed in the JP-A 10-228912 (Kokai), element added for suppressing the catalyst poisoning (group 6 element in this embodiment) can be more solid-solved. Therefore, by the degree thereof, the poison resistance to carbon monoxide can be improved.

Moreover, compared to the case in which ruthenium (Ru), which is a platinum group element that is the same as platinum (Pt) having high scarcity value in the same as the above-described case of Comparative example 2, the catalyst that is advantageous in the aspect of material cost can be obtained.

Next, a method for producing a fuel electrode catalyst according to an embodiment of this invention will be exemplified.

First, the case in which molybdenum (Mo) is solid-solved to its solid solubility limit with maintaining a face-centered cubic structure that is a basic structure of platinum (Pt) crystal will be explained.

The component ratio of the platinum-molybdenum solid solution of this case is 80 atom % (at %):20 atom % (at %). Its lattice constants are a=b=c=3.97 angstrom.

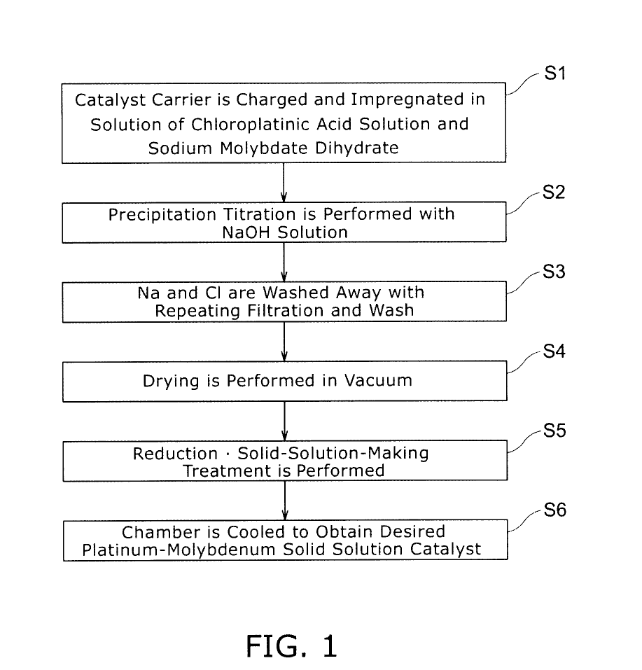

FIG. 1 is a flow chart for explaining the method for producing a fuel electrode catalyst according to a first embodiment of this invention.

First, a catalyst carrier is put in a solution of a chloroplatinic acid (H₂PtCl₆) solution and sodium molybdate dihydrate (Na₂MoO₄.2H₂O), which are catalyst precursors, and stirred for a long time and impregnated (step S1).

Next, precipitation titration is performed with a NaOH solution at 80° C. (step S2).

And, after the end of the titration, filtration and wash are repeated to wash away Na and Cl (step 3).

Next, the obtained solid component is dried for a long time in vacuum at 120° C. (step S4).

The solid component obtained as described above is platinum hydrate and molybdenum oxide, and therefore, reduction solid-solution-making treatment is performed (step S5).

In the reduction solid-solution-making treatment, the obtained solid component and zirconium powder are heated at 500° C. for 6 hours on a quartz boat disposed in vacuum to reduce the both substances and thereby molybdenum is solid-solved into platinum.

Last, with cooling the chamber, the pressure is gradually returned to be atmospheric pressure, and thereby a desired platinum-molybdenum solid solution catalyst is obtained (step S6).

Next, the case in which tungsten (W) is solid-solved to its solid solubility limit with maintaining the face-centered cubic structure that is a basic structure of platinum (Pt) crystal will be explained.

The component ratio of the platinum-tungsten solid solution of this case is 50 atom % (at %):50 atom % (at %). Its lattice constants are a=b=3.96 angstrom, c=4.09 angstrom.

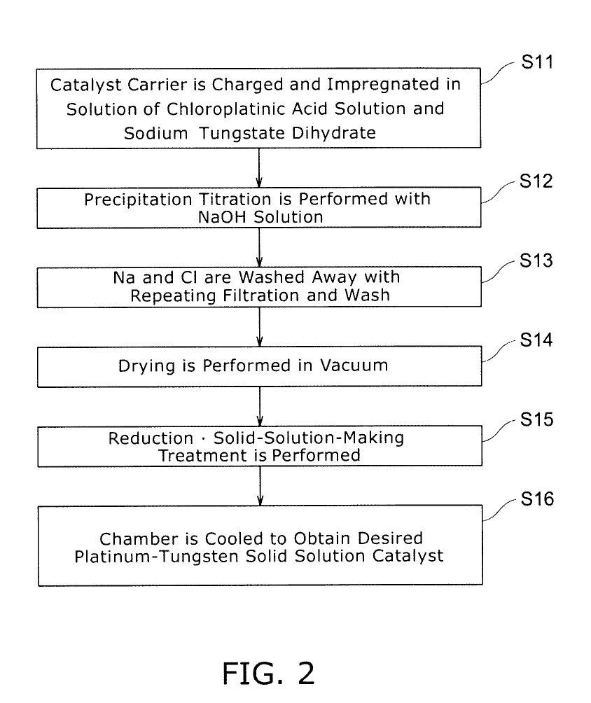

FIG. 2 is a flow chart for explaining the method for producing a fuel electrode catalyst according to a second embodiment of this invention.

First, a catalyst carrier is put in a solution of a chloroplatinic acid (H₂PtCl₆) solution and sodium tungstate dihydrate (Na₂WO₄.2H₂O), which are catalyst precursors, and stirred for a long time and impregnated (step S11).

Next, precipitation titration is performed with a NaOH solution at 80° C. (step S12).

And, after the end of the titration, filtration and wash are repeated to wash away Na and Cl (step 13).

Next, the obtained solid component is dried for a long time in vacuum at 120° C. (step S14).

The solid component obtained as described above is platinum hydrate and tungsten oxide, and therefore, reduction solid-solution-making treatment is performed (step S15).

In the reduction • solid-solution-making treatment, the obtained solid component and zirconium powder are heated at 500° C. for 6 hours on a quartz boat disposed in vacuum to reduce the both substances and thereby tungsten is solid-solved into platinum.

Last, with cooling the chamber, the pressure is gradually returned to be atmospheric pressure, and thereby a desired platinum-tungsten solid solution catalyst is obtained (step S16).

A platinum-chromium solid solution can be produced in the same method.

That is, it is sufficient that by the same procedure, platinum hydrate and chromium oxide are generated and the platinum hydrate and the chromium oxide are reduced and therewith the chromium (Cr) is solid-solved into the platinum (Pt).

Next, a fuel cell using a fuel electrode catalyst according to an embodiment of this invention will be exemplified.

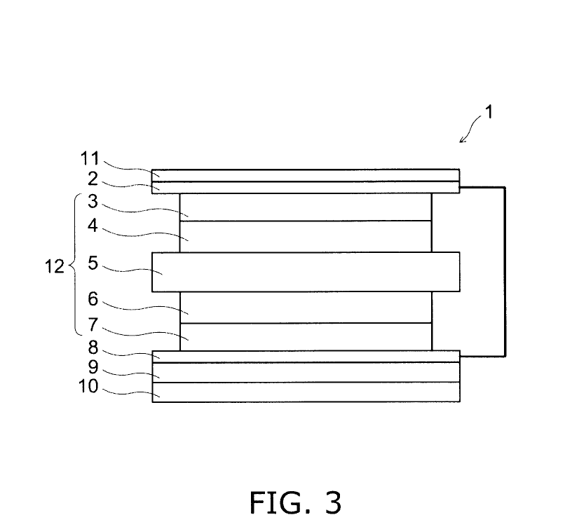

FIG. 3 is a schematic view for illustrating a fuel cell according to an embodiment of this invention.

For convenience of the explanation, the case of Direct Methanol Fuel Cell (DMFC) in which methanol serves as the fuel will be exemplified and explained.

As shown in FIG. 3, a fuel cell 1 includes as the electrogenic part Membrane Electrode Assembly (MEA) 12 having, a fuel electrode composed of a fuel electrode catalyst layer 6 containing the fuel electrode catalyst according to this embodiment and a fuel electrode gas diffusion layer 7, an air electrode composed of an air electrode catalyst layer 4 and an air electrode gas diffusion layer 3, and a solid polyelectrolyte membrane 5 sandwiched between the fuel electrode catalyst layer 6 and the air electrode catalyst layer 4.

Here, the fuel electrode catalyst layer 6 can include the above-described fuel electrode catalyst according to this embodiment. The air electrode catalyst layer 4 can include a simple metal or a solid solution containing platinum group element such as platinum (Pt), ruthenium (Ru), rhodium (Rh), iridium (Ir), osmium (Os), and palladium (Pd), or the like. The solid solution containing platinum group element can include platinum-nickel solid solution. However, the layer is not limited thereto but can be appropriately modified.

The catalysts contained in the fuel electrode catalyst layer 6 and the air electrode catalyst layer 4 may be a supported catalyst using a conductive supported body such as carbon material, or a non-supported catalyst.

The solid polyelectrolyte membrane 5 can include a membrane containing a proton conductive material as the main component such as, a fluorinated resin having a sulfonic group (such as perfluorosulfonate polymer), and hydrocarbon resin having a sulfonic group. However, the membrane is not limited thereto but can be appropriately modified.

In this case, the solid polyelectrolyte membrane 5 can be a membrane in which a solid polyelectrolyte material is filled in through-holes of the membrane composed of porous material or in openings provided in the membrane composed of inorganic material or can also be a membrane composed of a solid polyelectrolyte material.

The fuel electrode gas diffusion layer 7 provided so as to be stacked on the fuel electrode catalyst layer 6 plays a roll of uniformly supplying fuel to the fuel electrode catalyst layer 6, and the air electrode gas diffusion layer 3 stacked on the air electrode catalyst layer 4 plays a roll of uniformly supplying oxidant (oxygen) to the air electrode catalyst layer 4.

And, on the fuel electrode gas diffusion layer 7, a fuel electrode conductive layer 8 is provided to be stacked, and on the air electrode gas diffusion layer 3, an air electrode conductive layer 2 is provided to be stacked. The fuel electrode conductive layer 8 and the air electrode conductive layer 2 can be constructed by a porous layer such as a mesh made of conductive metal material such as gold or by a gilt having a plurality of openings or the like. And, the fuel electrode conductive layer 8 and the air electrode conductive layer 2 are electrically connected through a load, which is not shown.

The fuel electrode conductive layer 8 is connected to a liquid fuel tank 10 functioning as the fuel supply part, through a gas-liquid separation membrane 9. The gas-liquid separation membrane 9 functions as a gas-fuel-transmitting membrane that transmits only vaporizing component of the liquid fuel and does not transmit the liquid fuel.

The gas-liquid separation membrane 9 is disposed so as to block the openings, which is not shown, provided for guiding the vaporizing component of the liquid fuel in the liquid fuel tank 10. The gas-liquid separation membrane 9 separates the vaporizing component of the fuel and the liquid fuel and further evaporates the liquid fuel, and includes a membrane composed of such a material as silicone rubber.

Furthermore, the liquid fuel tank 10 side of the gas-liquid separation membrane 9 may be provided with a transmission-amount adjustment membrane, which is not shown, having the same gas-liquid separation function as the gas-liquid separation membrane 9 and further adjusting the transmission amount of the vaporizing component of the fuel. The adjustment of the transmission amount of the vaporizing component by the transmission-amount adjustment membrane is performed by modifying the opening ratio of the transmission-amount adjustment membrane. The transmission-amount adjustment membrane can be composed of such a material as polyethylene terephthalate. By providing the transmission-amount adjustment membrane, the gas-liquid separation of the fuel becomes possible and the supply amount of the vaporizing component of the fuel supplied to the fuel electrode catalyst layer 6 side can be adjusted.

Here, the liquid fuel stored in the liquid fuel tank 10 can be a methanol aqueous solution having a concentration of more than 50 mole % or a pure methanol. In this case, purity of the pure methanol can be from 95% by weight to 100% by weight. Moreover, the vaporizing component of the liquid fuel means, for example, vaporizing methanol when the pure methanol is used as the liquid fuel and a mixed gas composed of the vaporizing component of methanol and the vaporizing component of water when a methanol aqueous solution is used as the liquid fuel.

On the other hand, on the air electrode conductive layer 2, a cover 11 is provided so as to be stacked. In the cover 11, a plurality of air inlets, which is not shown, for taking air that is oxidant (oxygen) therein are provided. The cover 11 also plays a roll of pressurizing the membrane electrode assembly 12 to enhance the adhesion, and therefore, can be formed by such a metal as SUS304.

Next, an action of the fuel cell 1 according to this embodiment will be explained.

A methanol aqueous solution (liquid fuel) in the liquid fuel tank 10 is evaporated, and thereby, the generated vaporizing mixed gas of the methanol and water vapor transmits the gas-liquid separation membrane 9. And, the mixed gas passes through the fuel electrode conductive layer 8 and is diffused in the fuel electrode gas diffusion layer 7 to be supplied to the fuel electrode catalyst layer 6. The mixed gas supplied to the fuel electrode catalyst layer 6 generates oxidation represented by the following formula (1)

CH₃OH+H₂O→CO₂+6H⁺+6e⁻ (1)

In the case of using pure methanol as the liquid fuel, there is no supply of water vapor from the liquid fuel tank 10, and therefore, water generated in the air electrode catalyst layer 4 or water generated in the solid polyelectrolyte membrane 5 or the like to be described layer and methanol generate oxidation of the above-described formula (1).

The proton (H⁺) generated in the above-described oxidation of the formula (1) is conducted to the solid polyelectrolyte membrane 5 and reaches the air electrode catalyst layer 4. Moreover, the electron (e⁻) generated by the above-described oxidation of the formula (1) is supplied to the load, which is not shown, from the fuel electrode conductive layer 8 and performs work in the load and then reaches the air electrode catalyst layer 4 through the air electrode conductive layer 2 and the air electrode gas diffusion layer 3.

The air taken in from the air inlets, which is not shown, of the cover 11 permeates the air electrode conductive layer 2 and is diffused in the air electrode gas diffusion layer 3 and supplied to the air electrode catalyst layer 4. Oxygen in the air supplied to the air electrode catalyst layer 4 and the proton (H⁺) and the electron (e⁻) that reach the air electrode catalyst layer 4 generate the reaction represented by the following formula (2) to generate water.

(3/2)O₂+6H⁺+6e⁻→3H₂O (2)

Some water generated in the air electrode catalyst layer 4 by the reaction is diffused in the air electrode gas diffusion layer 3 to be evaporated from the air inlets, which is not shown, of the cover 11. In this case, evaporation of the residual water is inhibited by the cover 11. In particular, if the reaction of the formula (2) progresses, the water amount whose evaporation is inhibited by the cover 11 increases and the moisture storage amount in the air electrode catalyst layer 4 increases. And, with progress of the reaction of the formula (2), the moisture storage amount in the air electrode catalyst layer 4 becomes in a state of being larger than that of the moisture storage amount in the fuel electrode catalyst layer 6.

As a result, by osmotic-pressure phenomenon, the water generated in the air electrode catalyst layer 4 passes through the solid polyelectrolyte membrane 5 and moves to the fuel electrode catalyst layer 6. Therefore, compared to the case in which the supply of moisture to the fuel electrode catalyst layer 6 is drawn from only water vapor vaporizing from the liquid fuel tank 10, the supply of moisture is more promoted and the above-described reaction of the formula (1) can be promoted. Thereby, the output density can be enhanced, and therewith, the high output density can be maintained for a long period.

Also, in the case of using a methanol aqueous solution having a methanol concentration of more than 50 mole % or pure methanol as the liquid fuel, it becomes possible to use the water moving from the air electrode catalyst layer 4 to the fuel electrode catalyst layer 6 for the above-described reaction of the formula (1). Moreover, the resistance of the reaction of the above-described formula (1) can further be lowered and the long-term output characteristics and load current characteristics can be more improved. Furthermore, the downsizing of the liquid fuel tank 10 can be also achieved.

Moreover, in the fuel electrode catalyst 6, the fuel electrode catalyst according to this embodiment is contained, and therefore, the carbon monoxide generated in the above-described oxidation of the formula (1) is preferentially adsorbed to atom of the group 6 element that is “approximated” to platinum (Pt) (such as chromium (Cr), molybdenum (Mo), or tungsten (W)) to inhibit adsorption to platinum (Pt), and also when carbon monoxide is adsorbed to platinum (Pt), the dissociation thereof can be made to be easy. Therefore, poison resistance of the fuel electrode catalyst to carbon monoxide is improved to maintain the function of the fuel electrode of the fuel cell 1 for a long time.

Next, a method for producing the fuel cell 1 according to this embodiment will be explained.

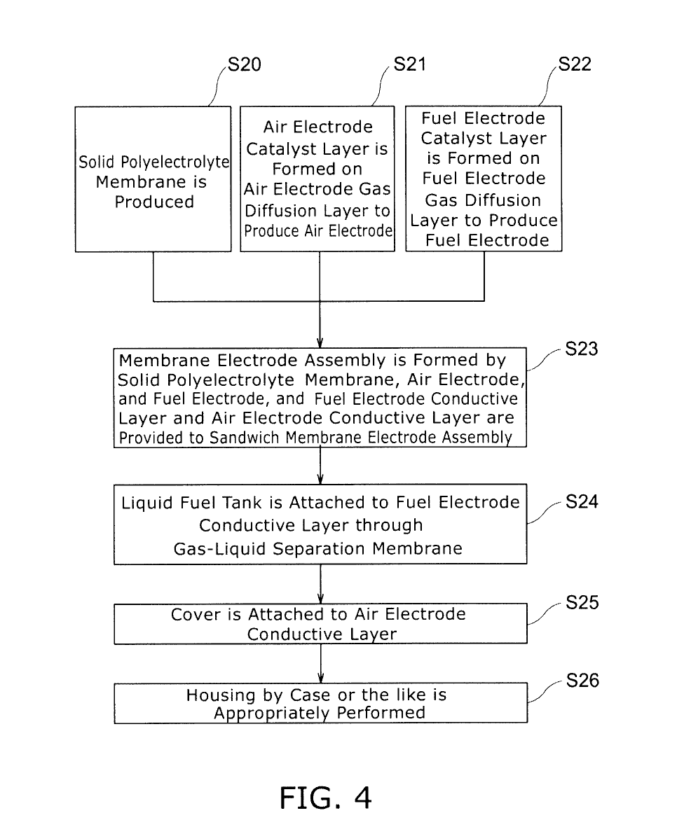

FIG. 4 is a flow chart for explaining a method for producing a fuel cell according to an embodiment of this invention.

First, a porous material membrane is produced by using a chemical or physical method such as phase separation method, foaming method, and sol-gel method. For the porous material membrane, commercially available porous material may be appropriately used. For example, polyimide porous membrane having a thickness of 25 micrometer and an opening rate of 45% (Upilex PT manufactured by Ube Industries Co., Ltd.) can be used.

And, the solid polyelectrolyte is filled in the porous material membrane to produce the solid polyelectrolyte membrane 5 (step S20). The method for filling the polyelectrolyte includes a method of immersing the porous material membrane in a electrolyte solution, taking up and drying the membrane, and removing the solvent. The electrolyte solution includes Nafion (registered trademark, manufactured by DuPont Co., Ltd.). The solid polyelectrolyte membrane 5 may be a membrane made of a polyelectrolyte material. In this case, production of the porous material membrane and filling of solid polyelectrolyte become needless.

Next, the air electrode gas diffusion layer 3 is produced by impregnating PTFE (Polytetrafluoroethylene) into a porous carbon fabric cloth or a carbon paper. And, fine particles of platinum (Pt), particulate or fabric carbon such as active carbon or graphite, and a solvent are mixed to be in a paste form and applied thereto and dried in normal temperature, and thereby, made to be the air electrode catalyst layer 4, and thereby, the air electrode is produced (step S21).

On the other hand, the fuel electrode gas diffusion layer 7 is produced by impregnating PTFE (Polytetrafluoroethylene) into a porous carbon fabric cloth or a carbon paper. And, fine particles of the above-described fuel electrode catalyst according to this embodiment (such as platinum-molybdenum solid solution and platinum-tungsten solid solution), particulate or fabric carbon such as active carbon or graphite, and a solvent are mixed to be in a paste form and applied thereto and dried in normal temperature, and thereby, made to be the fuel electrode catalyst layer 6, and thereby, the fuel electrode is produced (step S22).

Next, the membrane electrode assembly 12 is formed by the solid polyelectrolyte membrane 5, the air electrode (air electrode catalyst layer 4, air electrode gas diffusion layer 3), and the fuel electrode (fuel electrode catalyst layer 6, fuel electrode gas diffusion layer 7), and the fuel electrode conductive layer 8 and the air electrode conductive layer 2 that are composed of gilt or the like having a plurality of openings for taking in the vaporizing methanol or air are provided so as to sandwich the assembly (step S23).

Next, to the fuel electrode conductive layer 8, the liquid fuel tank 10 is attached through the gas-liquid separation membrane 9 (step S24). For the gas-liquid separation membrane 9, for example, silicone coat can be used.

Next, to the air electrode conductive layer 2, the cover 11 is attached (step S25). The cover 11 can be made of stainless steel plate (SUS304) in which the air inlets, which is not shown, for taking in air are formed.

Last, this is appropriately housed in a case, and so forth, and thereby, the fuel cell 1 is formed (step S26).

For convenience of the explanation, the fuel cell using liquid fuel is exemplified and explained. However, the fuel electrode catalyst according to this embodiment can also be applied to the fuel electrode of the fuel cell using gas fuel. For example, the catalyst can be applied to the fuel cell in which hydrogen gas (fuel gas) and air (oxidant gas) are supplied to the fuel electrode and the air electrode respectively and thereby electrochemical reaction is generated to obtain electric energy, and so forth. In this case, the catalyst in which hydrogen generated by inducing water-vapor modification reaction in carbon hydrate (such as kerosene, city gas, or LPG) serves as the fuel can be used.

Here, in the case that carbon hydrate (such as kerosene, city gas, or LPG) serves as the fuel, carbon monoxide is contained in the gas, and therefore, there is caused the problem of catalyst poisoning that the carbon monoxide is adsorbed onto the platinum catalyst surface to reduce the catalyst surface area that is effective in the chemical reaction of the gas fuel. Therefore, by performing gas modification or by preliminarily oxidizing the carbon monoxide, hydrogen having high purity is purified. However, it is difficult to completely suppress the catalyst poisoning due to carbon monoxide.

Even in such a case, in the fuel electrode catalyst according to this embodiment, carbon monoxide is preferentially adsorbed to atom group 6 element (such as chromium (Cr), molybdenum (Mo), or tungsten (W)) that is “approximated” to platinum (Pt) to inhibit adsorption to platinum (Pt), and the dissociation becomes easy even when carbon monoxide is adsorbed to platinum (Pt). Therefore, poison resistance of fuel electrode catalyst to carbon monoxide can be improved to maintain the function of the fuel electrode of the fuel cell for a long time.

The fuel electrode catalyst applied to the fuel electrode of the fuel cell using the gas fuel is the same as the above-described fuel electrode catalyst and therefore the explanation thereof is omitted. Moreover, the method for producing the fuel electrode catalyst is the same and therefore the explanation thereof is omitted.

The fuel cell using the gas fuel can also include the fuel electrode for oxidizing hydrogen gas, the air electrode to which oxygen gas (oxidant) is supplied, and the solid polyelectrolyte membrane provided to be sandwiched between the fuel electrode and the air electrode. Therefore, the structure or the producing method of such a fuel cell is also the same as the above-described fuel cell, and therefore, the explanation thereof is omitted.

Hereinafter, embodiments of this invention have been explained. However, this invention is not limited to these descriptions.

The above-described embodiments to which design modification is added by those skilled in the art are included in the scope of this invention as long as having the characteristics of this invention.

For example, shape, size, material, arrangement, and so forth of each of the components of the above-described fuel cells are not limited to the exemplified ones but can be appropriately modified.

Moreover, all of the catalysts contained in the fuel electrode are not necessarily the fuel electrode catalyst according to this embodiment but it is sufficient that the main component is the fuel electrode catalyst according to this embodiment. However, as the contained amount is larger, the poison resistance to carbon monoxide can be more improved.

Moreover, the fuel cell composed of a simple membrane electrode assembly has been illustrated but a stacking structure in which a plurality of the membrane electrode assemblies are stacked is possible.

Moreover, a methanol aqueous solution has been exemplified as the fuel but this is also not limited thereto, and in the same manner for another liquid fuel, the effect of suppressing the catalyst poisoning due to carbon monoxide can be expected. The another liquid fuel can include an alcohol such as ethanol and propanol other than methanol, an ether such as dimethyl ether, a cycloparaffin such as cyclohexane, a sugar group, and a cycloparaffin having a hydrophilic group such as hydroxyl group, carboxyl group, amino group, and amide group. Such a liquid fuel can be generally used as an aqueous solution of approximately 5-90% by weight.

Moreover, each of the components that each of the above-described embodiments includes can be combined if at all possible, and the combination thereof is also included in the scope of this invention as long as containing the characteristics of this invention.

1. A fuel electrode catalyst comprising:
a solid solution of platinum (Pt) and molybdenum (Mo),
a crystal structure of the solid solution being a face-centered cubic structure, and
a component ratio of the molybdenum (Mo) in the solid solution being from 10 atom % (at %) to 20 atom % (at %).

2. The fuel electrode catalyst according to claim 1, wherein the molybdenum (Mo) is solid-solved to reduce activation energy required for dissociating carbon monoxide from the catalyst surface.

3. The fuel electrode catalyst according to claim 1, wherein carbon monoxide is preferentially adsorbed to the molybdenum (Mo) in the solid solution.

4. The fuel electrode catalyst according to claim 1, wherein tungsten (W) is further included in the solid solution.

5. A fuel electrode catalyst comprising:
a solid solution of platinum (Pt) and tungsten (W),
a crystal structure of the solid solution being a face-centered cubic structure, and
a component ratio of the tungsten (W) in the solid solution being from 10 atom % (at %) to 50 atom % (at %).

6. The fuel electrode catalyst according to claim 5, wherein the tungsten (W) is solid-solved to reduce activation energy required for dissociating carbon monoxide from the catalyst surface.

7. The fuel electrode catalyst according to claim 5, wherein carbon monoxide is preferentially adsorbed to the tungsten (W) in the solid solution.

8. The fuel electrode catalyst according to claim 5, wherein molybdenum (Mo) is further included in the solid solution.

9. A method for producing a fuel electrode catalyst, comprising:
generating platinum hydrate and molybdenum oxide from chloroplatinic acid (H₂PtCl₆) and sodium molybdate dihydrate (Na₂MoO₄.2H₂O);
reducing the platinum hydrate and the molybdenum oxide; and therewith
solid-solving molybdenum (Mo) into platinum (Pt).

10. The method for producing a fuel electrode catalyst according to claim 9, wherein a component ratio of the solid-solved molybdenum (Mo) is from 10% atom (at %) to 20 atom % (at %).

11. The method for producing a fuel electrode catalyst according to claim 9, wherein the platinum hydrate and the molybdenum oxide is heated under a low-pressure environment to perform the reduction and therewith the molybdenum (Mo) is solid-solved into the platinum (Pt).

12. A method for producing a fuel electrode catalyst, comprising:
generating platinum hydrate and tungsten oxide from chloroplatinic acid (H₂PtCl₆) and sodium tungstate dihydrate (Na₂WO₄.2H₂O);
reducing the platinum hydrate and the tungsten oxide; and therewith
solid-solving tungsten (W) into platinum (Pt).

13. The method for producing a fuel electrode catalyst according to claim 12, wherein a component ratio of the solid-solved tungsten (W) is from 10% atom (at %) to 50 atom % (at %).

14. The method for producing a fuel electrode catalyst according to claim 12, wherein the platinum hydrate and the tungsten oxide is heated under a low-pressure environment to perform the reduction and therewith the tungsten (W) is solid-solved into the platinum (Pt).

15. A fuel cell comprising:
a fuel electrode to which fuel is supplied;
an air electrode to which oxidant is supplied; and
a solid polyelectrolyte membrane provided to be sandwiched between the fuel electrode and the air electrode,
the fuel electrode including a fuel electrode catalyst including:
a solid solution of platinum (Pt) and molybdenum (Mo),
a crystal structure of the solid solution being a face-centered cubic structure, and
a component ratio of the molybdenum (Mo) in the solid solution is from 10 atom % (at %) to 20 atom % (at %).

16. The fuel cell according to claim 15, wherein the fuel is a methanol aqueous solution having a concentration of more than 50 mole % or a pure methanol.

17. A fuel cell comprising:
a fuel electrode to which fuel is supplied;
an air electrode to which oxidant is supplied; and
a solid polyelectrolyte membrane provided to be sandwiched between the fuel electrode and the air electrode,
the fuel electrode including the fuel electrode catalyst including:
a solid solution of platinum (Pt) and tungsten (W),
a crystal structure of the solid solution being a face-centered cubic structure, and
a component ratio of the tungsten (W) in the solid solution being from 10 atom % (at %) to 50 atom % (at %).

18. The fuel cell according to claim 17, wherein the fuel is a methanol aqueous solution having a concentration of more than 50 mole % or a pure methanol.

19. A method for producing a fuel cell including a fuel electrode to which fuel is supplied, an air electrode to which oxidant is supplied and a solid polyelectrolyte membrane provided to be sandwiched between the fuel electrode and the air electrode, comprising:
producing a fuel electrode catalyst contained in the fuel electrode by a method for producing a fuel electrode catalyst including:
generating platinum hydrate and molybdenum oxide from chloroplatinic acid (H₂PtCl₆) and sodium molybdate dihydrate (Na₂MoO₄.2H₂O);
reducing the platinum hydrate and the molybdenum oxide; and therewith
solid-solving molybdenum (Mo) into platinum (Pt).

20. A method for producing a fuel cell including a fuel electrode to which fuel is supplied, an air electrode to which oxidant is supplied and a solid polyelectrolyte membrane provided to be sandwiched between the fuel electrode and the air electrode, comprising:
producing a fuel electrode catalyst contained in the fuel electrode by a method for producing a fuel electrode catalyst including:
generating platinum hydrate and tungsten oxide from chloroplatinic acid (H₂PtCl₆) and sodium tungstate dihydrate (Na₂WO₄.2H₂O);
reducing the platinum hydrate and the tungsten oxide; and therewith
solid-solving tungsten (W) into platinum (Pt).
